(19) United States
(12) Patent Application Publication
(10) Pub. No.: US 2025/0189225 A1
(43) Pub. Date: Jun. 12, 2025

(54) DRYING SYSTEM AND METHOD FOR DRYING A PRODUCT

(71) Applicant: G. LARSSON STARCH TECHNOLOGY AB, Bromölla (SE)

(72) Inventors: Magnus LARSSON, Karlshamn (SE); Daniel LINGSTRÖM, Åhus (SE); Nemo IVARSSON, Enskede (SE); Mats ANDERSSON, Hörby (SE)

(73) Assignee: G. LARSSON STARCH TECHNOLOGY AB, Bromölla (SE)

(21) Appl. No.: 18/838,881

(22) PCT Filed: Feb. 10, 2023
(86) PCT No.: PCT/EP2023/053334

§ 371 Date: Aug. 15, 2024

(30) Foreign Application Priority Data
Feb. 17, 2022 (EP) 22157203.5

(51) Int. Cl. F26B 17/10

(52) U.S. Cl. CPC F26B 17/103; F26B 2200/08

(57) ABSTRACT

A drying system for drying a product. The drying system having a drying tube including an air inlet, an air outlet, and a product inlet arranged in a side wall of the drying tube between the air inlet and the air outlet, and a drying injector connected to the product inlet of the drying tube. The drying injector is adapted to supply the product into the drying tube through the product inlet, such that the product is spread over a flashing area or a flashing volume within the drying tube. The invention also relates to a flash dryer and a method for drying a product.

### TECHNICAL FIELD

The invention relates to a drying system for drying a product and a method and flash dryer for drying a product.

### BACKGROUND ART

A flash dryer is used for continuous drying of a filter cake, solid particles, fibrous materials, paste, sludge or similar materials. The flash dryer can use an internal or external rotary disintegrator, mill or impeller rotor for disintegration of the material, placed on the outside at the product inlet or inside the dryer in the hot air stream, and provides a change of the structure of the material from the lump, paste or fibrous structure to a more particle shaped structure which is more suitable during the drying and forming the finished end product. Apertures are provided in a flash dryer for supply of hot drying gas and for removal of the spent drying gas and removal of the dried material.

Traditional technology for feeding moist powder material into a flash dryer without an internal disintegrator is typically constituted by a high-speed feeder screw, a kick-mill or a slinger. The traditional techniques have the disadvantage that the moist powder is fed into a concentrated point in the drying tube with a pulsating flow of lumps/aggregates formed by the moist particle feed material itself and/or the traditional powder feeding technology referred to.

At equilibrium conditions the form of the moisture retention in a powder and particle material, is a function of the nature of the solids, the ambient humidity, the temperature and the pressure. Moisture will be present as adsorbed vapour in the particle if the humidity is below a critical value and as liquid bridges for higher humidities, of which the later is the case of moist feed material into a flash dryer. The bonding between particles is caused by the overlapping of the adsorbed layers of neighbouring particles and its strength will be proportional to the tensile strength of the adsorbed film and the area of contact between particles. The adhesional force requires contact between particles to form cohesiveness. The strength of the structure will be a function of the contact area between particles and will be influenced by packing density, particle shape, particle size and particle roughness. When the relative humidity reaches and exceeds the critical point at which liquid bridges form between particles in a powder material, like in moist feed particle material to a flash dryer, then there is an incremental increase in the bond strength between particles and an increased likelihood of the powder having a cohesive nature forming aggregates and lumps. Once a liquid bridge is formed, it exerts an attractive cohesive force between particles. The forces can be large enough to cause a restructuring of a static powder and can be one of the causes of ‘lumping’ and crust formation in powders and particle materials.

A traditional feeder screw, kick mill or slinger, in itself creates lumps in the moist feed material by its mechanical treatment of the moist feed material, due to the liquid bridges in the material enhancing the cohesive forces between particles, leading to an uneven drying of the moist powder. The uneven drying of lump material can locally on starch particles or granules create so called local gelatinization of starch granules and aggregates of starch particles, i.e., local boiling of starch particles or granules leading to cracked and damaged native starch particles or granules. This is an unwanted effect at drying of starch. Any moist feed material with a likelihood of creating lumps mechanically treated in a feeder screw, kick mill or slinger, being used as feeding system into a flash dryer, will be dried on the aggregate/lump surface but not to the same extent in the centre of the aggregate/lump on individual particle basis.

### SUMMARY OF THE INVENTION

It is an object of the present invention to provide an improvement of the flash dryers according to prior art. A particular object is to provide a new technology for improved efficiency in drying powder materials in industrial processes, e.g., in the starch industry.

According to a first aspect, these and other objects, and/or advantages that will be apparent from the following description of embodiments, are achieved, in full or at least in part, by a drying system for drying a product. The drying system comprises a drying tube having an air inlet, an air outlet, and a product inlet arranged in a side wall of the drying tube between the air inlet and the air outlet, and a drying injector connected to the product inlet of the drying tube. The drying injector is adapted to supply the product into the drying tube through the product inlet, such that the product is spread over a flashing area or a flashing volume within the drying tube.

This is advantageous in that the product is spread from the product inlet in the dryer tube over the cross-sectional area of the drying tube along its axial direction, thereby creating a large surface of the product available for the hot air to dry the powder. In other words, the drying area—or drying volume—in the drying tube is greatly enlarged compared to when the traditional feeder screw is used instead of the drying injector. While spraying the product (normally moist powder) into the hot air stream in the drying tube, the contact surface between product particles and hot air stream is maximized, which creates a more efficient evaporation of water from the product (moist powder granules).

An effect of the above is that no shutdown periods for removing accumulated product in the bottom of the flash dryer will be necessary since basically all of the product inputted through the product inlet will be dried and thereafter outputted from the flash dryer.

A dryer injector that breaks the aggregates and lumps in moist feed material and spreads the moist powder with a continuous non-pulsating even flow rate evenly dispersed in a controlled manner over the entire cross-sectional area of the drying tube creates a larger surface of the powder available for the hot air to dry the powder evenly and gently, with less local overheating of the feed material and evaporate the water in a more efficient way. This will lead to a more lenient drying process and in turn to an improved product quality.

The spread of the product over a larger area or volume is extra crucial when handling a temperature sensitive product.

The new and innovative drying system is estimated to be lower in energy consumption at drying of starch. There will be a potential capacity increase of an existing flash dryer, which is retrofitted with the drying system according to the present invention, due to more efficient drying properties.

The drying injector may be adapted to supply the product into the drying tube in a first primary supply direction which is angled in relation to an imaginary horizontal axis, and in a second primary supply direction which is angled in relation to an imaginary line between the product inlet and a centre point of the drying tube in a radial plane thereof.

The drying injector may comprise at least one outflow unit directing the product in the first primary supply direction and in the second primary supply direction by means of a plurality of individual outflow grooves provided therein.

The at least one of the outflow grooves may be inclined, oblong, round or fishbone shaped.

A vertical outflow angle (VOA) between the first primary supply direction and the imaginary horizontal axis may be provided in the range of +/−65 degrees by the plurality of individual outflow grooves in the at least one outflow unit.

A radial outflow angle (ROA) between the second primary supply direction and the imaginary line between the product inlet and the centre point of the drying tube in a radial plane thereof may be provided in the range of +/−75 degrees by the plurality of individual outflow grooves in the at least one outflow unit.

The drying injector may be a continuous mixer, and the at least one outflow unit is an outflow passage for mixed final product to be dried.

The flashing volume may be constituted by a volume created by the cross-sectional area of the drying tube along a predetermined distance in an axial direction therein.

The product to be dried in the drying system may be constituted by wet powder particles mixed in the drying injector.

The drying injector may be angled in relation to the drying tube.

According to a second aspect, the objects are achieved in full, or at least in part, by a flash dryer for drying a product, comprising the drying system according to the features described above.

According to a third aspect, the objects are achieved in full, or at least in part, by a method for drying a product in a drying system. The drying system comprises a drying tube having an air inlet, an air outlet, and a product inlet arranged in a side wall of the drying tube between the air inlet and the air outlet, and a drying injector connected to the product inlet of the drying tube. The method comprises providing heated air into the drying tube via the air inlet thereof, and supplying the product into the drying tube, such that the product is spread over a flashing area or flashing volume within the drying tube.

The method may further comprise the step of mixing the product into wet powder particles before the step of providing the product into the drying tube.

The step of mixing the product into wet powder particles before the step of providing the product into the drying tube further may comprise admixing further particles or fluid to be dried with the product.

A vertical outflow angle (VOA) between first primary supply direction and the imaginary horizontal axis may be in the range of +/−65 degrees.

A radial outflow angle (ROA) between the second primary supply direction and the imaginary line between the product inlet and a centre point of the drying tube in a radial plane thereof may be in the range of +/−75 degrees.

The vertical outflow angle (VOA) and the radial outflow angle (ROA) may be adjustable.

The step of providing the product into the drying tube in a first primary supply direction which may be angled in relation to an imaginary horizontal axis comprises providing the product into the drying tube in the first primary supply direction which is angled in relation to an imaginary horizontal axis in the range of 0 to +75 degrees, and providing the product into the drying tube in a further first primary supply direction which is angled in relation to an imaginary horizontal axis in the range of 0 to −75 degrees, simultaneously.

The step of providing the product into the drying tube in a second primary supply direction which may be angled in relation to an imaginary line between the product inlet and a centre point of the drying tube in a radial plane thereof comprises providing the product into the drying tube in the second primary supply direction which is angled in relation to an imaginary line between the product inlet and a centre point of the drying tube in a radial plane thereof in the range of 0 to +65 degrees, and providing the product into the drying tube in a further second primary supply direction which is angled in relation to an imaginary line between the product inlet and a centre point of the drying tube in a radial plane thereof in the range of 0 to −65 degrees, simultaneously.

The method may further comprise the step of back-mixing at least a portion of the dried product from downstream of the drying tube to the drying injector or from downstream of the drying tube to upstream the drying injector.

It should be noted that the different embodiments of the drying system that is described above are exemplifying only. The embodiments may be combined with each other in any suitable way depending on the requirements established for the drying system.

It should be further noted that the different steps of the method described above may be conducted in any suitable order.

Effects and features of the second and third aspects of the present invention are largely analogous to those described above in connection with the first aspect of the inventive concept. Embodiments mentioned in relation to the first aspect of the present invention are largely compatible with the further aspects of the invention.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

As used herein, the term “comprising” and variations of that term are not intended to exclude other additives, components, integers or steps.

As used herein, the term “flash dryer” also includes a spin flash dryer or agitated fluid bed dryer.

By “flashing area” is meant a drying area within the drying tube.

By “flashing volume” is meant a drying volume within the drying tube.

### BRIEF DESCRIPTION OF THE DRAWINGS

The above objects, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1A illustrates a side view of an exemplary embodiment of a drying system according to a first aspect of the invention.

FIG. 1B illustrates a top view of a drying tube in the drying system.

FIG. 2A illustrates an exemplary embodiment of an outflow unit of a drying injector in the drying system.

FIG. 2B illustrates another exemplary embodiment of the outflow unit of the drying injector in the drying system.

FIG. 3 illustrates a front view of an exemplary embodiment a drying injector of the drying system.

FIG. 4 illustrates a side view of an exemplary embodiment of a flash dryer according to a second aspect of the invention.

### DETAILED DESCRIPTION OF PREFERRED EMBODIMENTS OF THE INVENTION

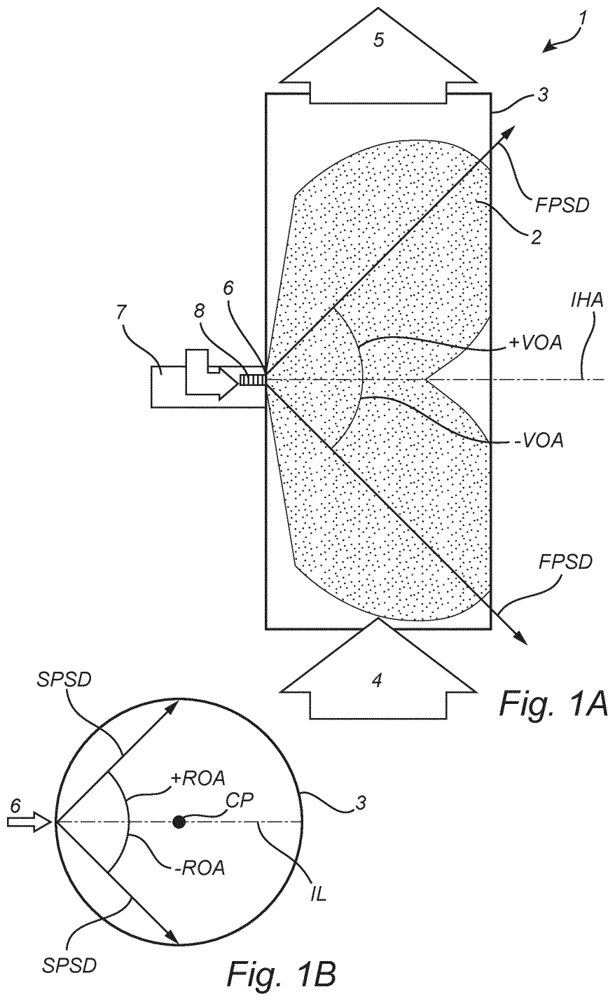

FIG. 1A illustrates an exemplary embodiment of a drying system 1 for drying a product 2. The drying system 1 comprises a drying tube 3 which has an air inlet 4, an air outlet 5, and a product inlet 6 arranged in a side wall of the drying tube 2 between the air inlet 4 and the air outlet 5. The drying system further comprises a drying injector 7 which is connected to the product inlet 6 of the drying tube 2. The drying injector 7 is adapted to supply the product 2 into the drying tube 3 through the product inlet 6 in a manner such that the product 2 is spread over a specific flashing area or a flashing volume within the drying tube 3. The product 2 to be dried in the drying system 1 is normally constituted by wet powder particles mixed in the drying injector 7. The flashing volume can for example be constituted by a volume created by the cross-sectional area of the drying tube 3 along a predetermined distance in an axial direction therein.

The drying tube 3 is hollow. The air inlet 4 is preferably positioned at the bottom of the drying tube 3. The perimeter of the bottom of the drying tube 3 forms the air inlet 4. The air outlet 5 is positioned at the top of the drying tube 3. The perimeter of the top of the drying tube 3 forms the air outlet 5. The drying tube 3 is naturally not limited to a certain geometric shape. For instance, the drying tube 3 can be cubic, spheric, pyramidal, conical, hexagonal prismatic, or a combination thereof. The cross-section of the drying tube 3 can for example be circular, square or rectangular. The air inlet 4 and/or the air outlet 5 can be square, circular, rectangular, triangular, hexagonal, or a combination thereof.

The drying injector 7 is adapted to supply the product 2 into the drying tube 3. The drying injector is capable of supplying the product into the drying tube 3 in one or several different directions in order to spread the product 2 into the drying tube 3 in any suitable manner and thus create the desired flashing area or a flashing volume within the drying tube 3. The drying injector 7 can for example be adapted to supply the product 2 into the drying tube 3 in a first primary supply direction FPSD which is angled in relation to an imaginary horizontal axis IHA. The first primary supply direction FPSD can be angled upwardly and/or downwardly in relation to the imaginary horizontal axis IHA. In other words, the product 2 can be supplied into the drying tube 3 in the first primary supply direction FPSD both upwardly and downwardly simultaneously (see FIG. 1A).

The drying injector 7 can also be adapted to, separately or simultaneously, supply the product 2 into the drying tube 3 in a second primary supply direction SPSD which is angled in relation to an imaginary line IL between the product inlet 6 and a centre point CP of the drying tube 3 in a radial plane thereof (see FIG. 1B). The second primary supply direction SPSD can be angled in a positive and/or negative angle in relation to the imaginary line IL. In other words, the product 2 can be supplied into the drying tube 3 also in the second primary supply direction SPSD both in a positive and in a negative angle in relation to the imaginary line IL simultaneously (see FIG. 1B).

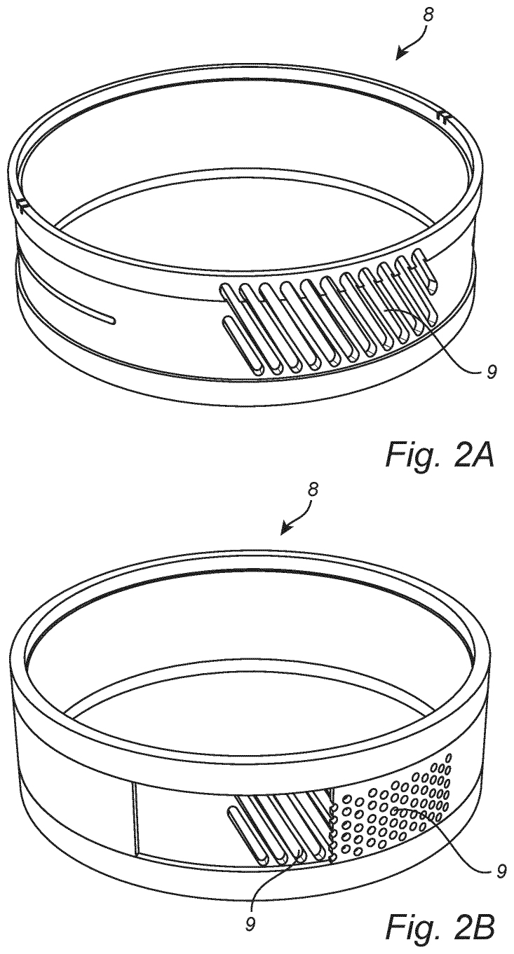

In one embodiment, the drying injector 7 comprises an outflow unit 8 (see FIGS. 2A and 2B). The outflow unit 8 is adapted to direct the product 2 in the first primary supply direction FPSD and in the second primary supply direction SPSD by means of a plurality of individual outflow grooves 9 provided therein. The outflow grooves 9 may have any suitable size and shape, such as inclined, oblong, round or fishbone shaped. Naturally, different grooves can have different shapes in the same outflow unit 8. The drying injector 7 can naturally also be equipped with more than one outflow unit 8.

A vertical outflow angle VOA between the first primary supply direction FPSD and the imaginary horizontal axis IHA can be provided in the range of +/−65 degrees by the plurality of individual outflow grooves 9 in the outflow unit 8.

A radial outflow angle ROA between the second primary supply direction SPSD and the imaginary line IL between the product inlet 6 and the centre point CP of the drying tube 3 in the radial plane thereof can be provided in the range of +/−75 degrees by the plurality of individual outflow grooves 9 in the outflow unit 8.

Moreover, it should be noted that also combinations of the different types of outflow grooves 9, such as both oblong and round, are possible. Furthermore, also combinations of different outflow units 8 are possible. One example is to provide an outflow unit 8 with oblong inclined outflow grooves 9 first and which then is complemented with another outflow unit 8 with round holes. Such a combination of one outflow unit 8 arranged outside of another outflow unit 8 can be of interest for certain applications, such as e.g., when producing a granulated particle material before drying.

Based on the above, there is provided a drying injector 7 which could comprise at least two outflow units 8 having different outflow grooves pattern in relation to each other, and which two outflow units 8 can be arranged as a first and then a second outside of the first, to complement each other. The second one is preferably arranged directly outside of the first outflow unit. One such example is shown in FIG. 2B.

In relation to inclination and shape, it should be noted that many different alternatives are possible. For instance, one example is a fishbone shape of the multiple individual outflow grooves 9. Therefore, the multiple individual outflow grooves 9 are arranged in a fishbone shape. Such a shape may be arranged in different ways. One example is as two rows of individual oblong grooves 9, which rows then are inclined different directions, and thus creating the fishbone shape. Moreover, a fishbone shape then enables spraying both upwards and downwards. Besides the shape of the outflow grooves 9 also other aspects are of interest in relation to features of the outflow. Non-limiting examples are the size of the outflow grooves 9, certain angles as disclosed below, the placement and shape of the grating material provided between the outflow grooves 9. Therefore, both holes or outflow grooves and grating material are of interest for the end result.

Moreover, several of the outflow grooves 9 can have the same shape, preferably wherein substantially all of the outflow grooves 9 have the same shape. As seen in the figures, this does not have to imply that all of the outflow grooves 9 have the same size. For instance, the end grooves may have the same general shape but have a smaller size than the rest of the grooves.

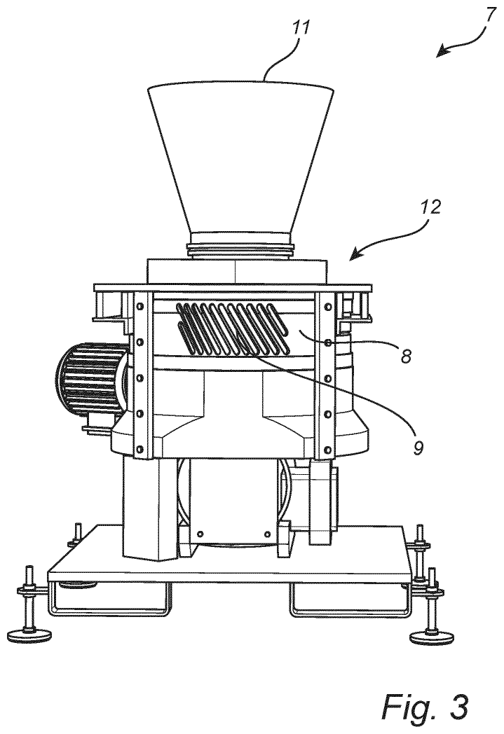

In FIG. 3, an exemplary embodiment of the drying injector 7 is illustrated. The inlet 11 of the drying injector 7 is placed on top of the mixer 12. When the product put into the mixer 12 via the inlet 11 has been mixed and disintegrated it is introduced into the drying tube 3 via the outflow unit 8. More specifically, the product exits the outflow unit 8 via its outflow grooves 9 and enters the drying tube 3 via its product inlet 6. The axial axis of the inlet 11 and the outflow unit 8 is parallel to the axial axis of the drying tube 3.

The mixer 12 comprises a mixing chamber wherein a most upper part of the outflow grooves is arranged above a top of the mixing chamber. This type of arrangement may be of interest to ensure that granules or material being produced are flowed out from the mixer 12 and no material or at least a small amount gets stuck or provides build up inside of the mixer 12. This type of arrangement provides a form of edge in the outflow unit 8 of the mixer device 12. This has proven to be efficient when mixing moist material and even dough material, but also other material types.

Furthermore, the top (or end ceiling) of the mixing chamber may be inclined upwards to ensure that all produced material is flown out from the mixing chamber and mixer 12 and does not loop inside of the mixing chamber to be mixed “another time” when such material, e.g. granules, are produced and thus mixed as intended.

The inlet 11 of the mixer 12 may be arranged with a movable scraper, preferably an arch breaker. The movable scraper is suitably arranged in relation to the inlet 11 to create an even inflow to the mixing chamber and thus an even flow to the outflow grooves 9.

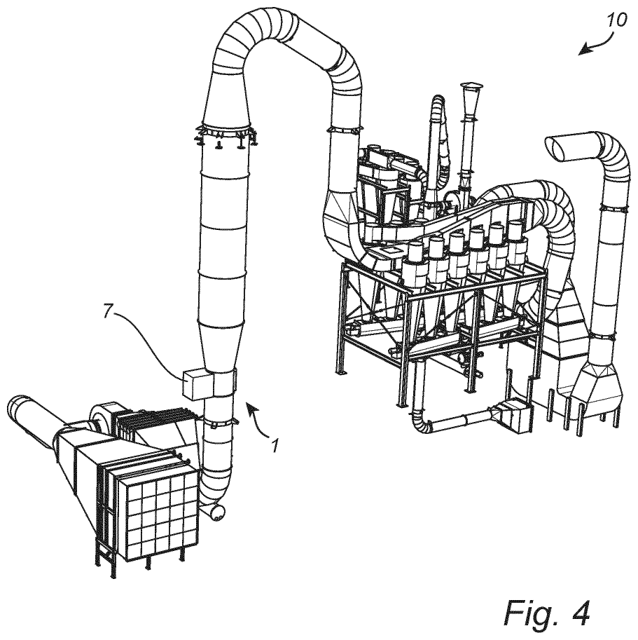

FIG. 4 illustrates an exemplary embodiment of a flash dryer 10 for drying a product 2. The drying system 1 described above forms part of the flash dryer 10.

One purpose of the invention is to be able to create a desired drying zone in the drying tube 3. The drying zone can be established by merely supplying the product 2 into the drying tube 3 in one single direction, such as in the first primary supply direction FPSD in an upward angle in relation to the imaginary horizontal axis IHA. Although supplying product into the drying tube 3 in one single direction, the product 2 will naturally spread somewhat so that a flashing area or flashing volume is created within the drying tube 3.

In another example, the product could be supplied into the drying tube 3 in four different primary directions; in the first primary supply direction FPSD in an upward angle in relation to the imaginary horizontal axis IHA, in the first primary supply direction FPSD in an downward angle in relation to the imaginary horizontal axis IHA, in the second primary supply direction SPSD angled in a positive angle in relation to the imaginary line IL, and in the second primary supply direction SPSD angled in a negative angle in relation to the imaginary line IL, which will create a large flashing volume within the drying tube 3.

When the product 2 is to be dried by means of the drying system 1, which forms part of the flash dryer 10, it is normally mixed into wet powder particles in the drying injector 7 before being supplied into the drying tube 3 therefrom. While heated air is supplied into the drying tube 3 via the air inlet 4, the product is introduced into the drying tube 3 in one or several primary directions, as described above, in order to achieve the desired flashing area or flashing volume where the product is 2 to be dried. When the product 2 has been dried to a satisfactory extent it will follow the heated air out of the drying tube 3 via the air outlet 5.

The flashing area or flashing volume is created by supplying the product 2 into the drying tube 3 in one or several primary directions which preferably are controlled by the shape and form of the outflow grooves 9 in the outflow unit(s) 8 of the drying injector 7.

The skilled person realizes that a number of modifications of the embodiments described herein are possible without departing from the scope of the invention, which is defined in the appended claims.

For instance, the drying injector 7 can be angled in relation to the drying tube 3 and more than one drying injector 7 can be arranged in a system creating multiple inlets of feeding product into the dryer.

The drying injector 7 can be a continuous mixer for solid particle mixing of two or more solid materials and/or solid particle and liquid mixing of two or more materials prior to drying, and the outflow unit 8 can be an outflow passage for mixed final product 2 to be dried.

The drying system 1 according to the present invention may be adapted based on the intended use. According to one specific embodiment, the size of the cross-sectional area of at least one of or several of the inlets 4, 6 is adjustable. This is a development to increase the adjustability of the system 1 even further without the need of changing or affecting other parts which may create a drying result or the like. The air outlet 5 may also be adjustable according to the present invention.

1. A drying system for drying a product, comprising:
a drying tube having:
an air inlet,
an air outlet, and
a product inlet arranged in a side wall of the drying tube between the air inlet and the air outlet, and a drying injector connected to the product inlet of the drying tube,
wherein the drying injector is adapted to supply the product into the drying tube through the product inlet, such that the product is spread over a flashing area or a flashing volume within the drying tube wherein the drying injector is adapted to supply the product into the drying tube in a first primary supply direction (FPSD) which is angled in relation to an imaginary horizontal axis (IHA), and in a second primary supply direction (SPSD) which is angled in relation to an imaginary line (IL) between the product inlet and a centre point (CP) of the drying tube in a radial plane thereof, and
wherein the drying injector comprises at least one outflow unit directing the product in the first primary supply direction (FPSD) and in the second primary supply direction (SPSD) by means of a plurality of individual outflow grooves provided therein.

2. The drying system according to claim 1, wherein at least one of the outflow grooves is inclined, oblong, round or fishbone shaped.

3. The drying system according to claim 1, wherein a vertical outflow angle (VOA) between the first primary supply direction (FPSD) and the imaginary horizontal axis (IHA) is provided in the range of +/−65 degrees by the plurality of individual outflow grooves in the at least one outflow unit.

4. The drying system according to claim 1, wherein a radial outflow angle (ROA) between the second primary supply direction (SPSD) and the imaginary line (IL) between the product inlet and the centre point (CP) of the drying tube in a radial plane thereof is provided in the range of +/−75 degrees by the plurality of individual outflow grooves in the at least one outflow unit.

5. The drying system according to claim 1, wherein the drying injector is a continuous mixer, and the at least one outflow unit is an outflow passage for mixed final product to be dried.

6. The drying system according to claim 1, wherein the flashing volume is constituted by a volume created by the cross-sectional area of the drying tube along a predetermined distance in an axial direction therein.

7. The drying system according to claim 1, wherein the product to be dried in the drying system is constituted by wet powder particles mixed in the drying injector.

8. The drying system according to claim 1, wherein the drying injector is angled in relation to the drying tube.

9. A flash dryer for drying a product, comprising the drying system according to claim 1.

10. A method for drying a product in a drying system, the drying system comprising:
a drying tube having:
an air inlet,
an air outlet, and
a product inlet arranged in a side wall of the drying tube between the air inlet and the air outlet, and
a drying injector connected to the product inlet of the drying tube, wherein the method comprises:
providing heated air into the drying tube via the air inlet thereof, and supplying the product into the drying tube, such that the product is spread over a flashing area or flashing volume within the drying tube, wherein the step of supplying the product into the drying tube comprises:
providing the product into the drying tube in a first primary supply direction (FPSD) which is angled in relation to an imaginary horizontal axis (IHA),
providing the product into the drying tube in a second primary supply direction (SPSD) which is angled in relation to an imaginary line (IL) between the product inlet and a centre point (CP) of the drying tube in a radial plane thereof, and
directing the product in the first primary supply direction (FPSD) and in the second primary supply direction (SPSD) by means of a plurality of individual outflow grooves provided therein by means of at least one outflow unit of the drying injector.

11. The method according to claim 10, further comprising the step of mixing the product into wet powder particles before the step of providing the product into the drying tube.

12. The method according to claim 15, wherein the step of mixing the product into wet powder particles before the step of providing the product into the drying tube further comprises admixing further particles or fluid to be dried with the product.

13. The method according to claim 10, wherein a vertical outflow angle (VOA) between first primary supply direction (FPSD) and the imaginary horizontal axis (IHA) is in the range of +/−65 degrees.

14. The method according to claim 10, wherein a radial outflow angle (ROA) between the second primary supply direction (SPSD) and the imaginary line (IL) between the product inlet and a centre point (CP) of the drying tube in a radial plane thereof is in the range of +/−75 degrees.

15. The method according to claim 13, wherein the vertical outflow angle (VOA) and the radial outflow angle (ROA) are adjustable.

16. The method according to claim 13, wherein the step of providing the product into the drying tube in a first primary supply direction (FPSD) which is angled in relation to an imaginary horizontal axis (IHA) comprises providing the product into the drying tube in the first primary supply direction (FPSD) which is angled in relation to an imaginary horizontal axis (IHA) in the range of 0 to +75 degrees, and providing the product into the drying tube in a further first primary supply direction (FPSD) which is angled in relation to an imaginary horizontal axis (IHA) in the range of 0 to −75 degrees, simultaneously.

17. The method according to claim 13, wherein the step of providing the product into the drying tube in a second primary supply direction (SPSD) which is angled in relation to an imaginary line (IL) between the product inlet and a centre point (CP) of the drying tube in a radial plane thereof comprises providing the product into the drying tube in the second primary supply direction (SPSD) which is angled in relation to an imaginary line (IL) between the product inlet and a centre point (CP) of the drying tube in a radial plane thereof in the range of 0 to +65 degrees, and providing the product into the drying tube in a further second primary supply direction (SPSD) which is angled in relation to an imaginary line (IL) between the product inlet and a centre point (CP) of the drying tube in a radial plane thereof in the range of 0 to −65 degrees, simultaneously.

18. The method according to claim 13, further comprising the step of back-mixing at least a portion of the dried product from downstream of the drying tube to the drying injector or from downstream of the drying tube to upstream the drying injector.

19. Using the drying system according to claim 1, to produce dried powders, cakes, fiber material, protein, granules, flakes, pastes, gels, slurries, starch particles and/or other particles suitable for drying in the drying system.
